(19) United States
(12) Patent Application Publication
(10) Pub. No.: US 2026/0263199 A1
(43) Pub. Date: Sep. 10, 2026

(54) ULTRASONIC MOTOR FOR DENTAL SCALER

(71) Applicant: Shenzhen Fortunecome Technology Co., Ltd., Shenzhen (CN)

(72) Inventor: Chenglong Fang, Shenzhen (CN)

(73) Assignee: Shenzhen Fortunecome Technology Co., Ltd., Shenzhen (CN)

(21) Appl. No.: 19/290,419

(22) Filed: Aug. 5, 2025

(30) Foreign Application Priority Data
Mar. 4, 2025 (CN) 202510246602.3

(51) Int. Cl. A61C 17/20

(52) U.S. Cl. CPC A61C 17/20

(57) ABSTRACT

The present invention discloses an ultrasonic motor for a dental scaler, and particularly relates to the field of motor technologies. The ultrasonic motor includes a housing, a stator, a rotor, and a motor drive range adjusting mechanism. The motor drive range adjusting mechanism includes a transmission shaft, a polarization shaft, a miniature electric cylinder, a connecting block, a concave block, two connecting shafts, a socket rod, a pull shaft, a hinge block, a socket block, limit strips, and an inner limit ring. The ultrasonic motor further includes a sealed vibration limit mechanism and a sensing calibration mechanism. With the motor drive range adjusting mechanism, the present invention resolves the problem that it is difficult to accurately adjust the vibration offset range of the output end of the ultrasonic motor according to actual needs.

### TECHNICAL FIELD

The present invention relates to the field of motor technologies, and in particular, to an ultrasonic motor for a dental scaler.

### BACKGROUND

The working principle of an ultrasonic motor in a dental scaler is mainly based on high-frequency vibration and cavitation, specifically based on high-frequency vibration: the ultrasonic motor can generate high-frequency vibration, and such vibration is transmitted to surfaces of teeth through a working head of the dental scaler. Under the action of vibration, deposits such as dental plaque and tartar are effectively decomposed and removed from the surfaces of teeth.

Among existing published documents, the patent with publication patent number CN117200504A discloses an ultrasonic motor for an electric toothbrush. The ultrasonic motor is shock-absorbed by using a shock absorber, so as to reduce motor vibration caused by axial runout of an output shaft, thereby reducing vibration and noise when a user uses the electric toothbrush, and improving the comfort of use. One end of the output shaft of the motor is sealed by using a spring and a sealing ring, and further sealed by using a sealing plate. The double sealing reduces the probability of water damage to the motor, and extends service life of the ultrasonic motor. However, the ultrasonic motor has the following problems.

Although the ultrasonic motor can provide high-frequency vibration when used in the dental scaler, coupled with ultrasonic transmission, it causes the drive to produce a certain range of vibration, and the vibration range is limited. For some narrow gaps, the vibration range of an output end of the ultrasonic motor is wide, which causes damage to the teeth, so it is difficult to accurately adjust a vibration offset range of the output end of the ultrasonic motor according to actual needs. Therefore, an ultrasonic motor for a dental scaler is needed.

### SUMMARY OF THE INVENTION

To overcome the above defects in the prior art, the present invention provides the following technical solution: an ultrasonic motor for a dental scaler, including a housing, a stator, and a rotor, where the stator is fixed on an inner wall of the housing, the rotor is rotatably connected to an inner wall of the stator, and a motor drive range adjusting mechanism is fixedly mounted at one end of the rotor; the motor drive range adjusting mechanism includes a transmission shaft fixedly disposed at one end of the rotor, and a polarization shaft is fixedly connected to one end of the transmission shaft, one side of the polarization shaft is provided with a miniature electric cylinder, a connecting block is fixedly connected to an output end of the miniature electric cylinder, and a concave block is fixedly connected to one side of the connecting block;

two connecting shafts are fixedly connected to an inner wall of the concave block, a socket rod is rotatably connected to an outer wall of each of the connecting shafts, a pull shaft is rotatably connected at a position that is on an inner wall of the socket rod and that is away from the connecting shaft, and a hinge block is fixedly connected to one end of the pull shaft; a socket block is fixedly connected to one side of the hinge block, a limit strip is fixedly mounted at one end of the socket block, and an inner limit ring is fixedly mounted at one end of the miniature electric cylinder; an inner wall of the inner limit ring is provided with a sealed vibration limit mechanism; and a sensing calibration mechanism is mounted on one side of the socket block.

Preferably, both the concave block and the hinge block have concave cross sections, and the pull shaft and the connecting shafts have circular vertical sections. The limit strip has an arc-shaped vertical section, and inner walls of both the limit strips are smooth surfaces. An inner wall of the socket block is provided with a guide column, and both the socket blocks are in sliding connection with the guide column; and a guide frame is fixedly mounted at the top of the guide column, both the socket blocks are in sliding connection with the guide frame, and the guide frame is fixedly connected with the inner limit ring.

Preferably, a rotating ring is fixedly connected at a position that is on an outer wall of the polarization shaft and that is close to the transmission shaft; and

an eccentric block is fixedly connected at the bottom of an outer wall of the rotating ring. One side of the transmission shaft is provided with an ultrasonic generator, and the ultrasonic generator is fixedly connected with the housing.

When the technical solution is used, a driving vibration range value is set by using a circuit board, then the miniature electric cylinder is powered by the circuit board, the connecting block causes the concave block to move to the right, the two connecting shafts respectively drive one ends of the two socket rods to move synchronously to the right, and the other ends of the socket rods drive the pull shaft to move downward and the other pull shaft to move upward. The hinge block drives the socket block to move downward, the socket block slides downward along an outer wall of the guide column, while the socket block slides downward along an inner wall of the guide frame, and the socket block causes the limit strip to move downward and the other limit strip to move upward.

Preferably, the sealed vibration limit mechanism includes a rubber ring fixedly disposed on an inner wall of the inner limit ring; the rubber ring is rotatably connected with the polarization shaft, an outer limit ring is mounted on an outer wall of the inner limit ring, both the housing and the inner limit ring are fixedly connected with the outer limit ring, a limit support ring is fixedly connected to one side of the inner limit ring, and the polarization shaft is rotatably connected with the limit support ring; and a tip is fixedly connected to one end of the polarization shaft. The rubber ring has an annular vertical section, and the rubber ring is made of a rubber material.

When the technical solution is used, the circuit board activates the stator, causing the rotor to rotate. The rotor then drives the transmission shaft to rotate, the polarization shaft drives the rotating ring to rotate, and the eccentric block rotates eccentrically. In addition, the ultrasonic generator can perform ultrasonic-assisted vibration on the transmission shaft, the transmission shaft can synchronously drive the polarization shaft to vibrate, and the rubber ring is in deformation linkage, so that the polarization shaft comes into contact with inner walls of the two limit strips, and the polarization shaft implements ultrasonic-driven vibration. The outer limit ring is supported by the housing, and the outer limit ring supports the inner limit ring, so that the inner limit ring can limit an outer wall of the rubber ring.

Preferably, the sensing calibration mechanism includes a support block fixedly disposed on one side of the socket block;

an inclined strip is fixedly connected to one side of the support block, a sleeve block is fixedly mounted at the bottom of the support block, a main distance sensor is fixedly connected to an inner wall of the sleeve block, a stationary sleeve block is disposed below the sleeve block, the stationary sleeve block is fixedly connected with the inner limit ring, and both the support block and the sleeve block are in sliding connection with the inner limit ring; and a calibration distance sensor is fixedly mounted on an inner wall of the stationary sleeve block, and a circuit board fixedly connected with the inner limit ring is disposed below the stationary sleeve block. A top surface of the calibration distance sensor is in the same horizontal plane as an upper surface of the stationary sleeve block, and a lower surface of the sleeve block is disposed in parallel with the upper surface of the stationary sleeve block.

When the technical solution is used, the support block is driven to move downward as the socket block moves downward, the inclined strip causes the sleeve block to move downward, the main distance sensor approaches the stationary sleeve block, and the sleeve block and the support block slide downward on the inner limit ring. The main distance sensor can sense a distance of the stationary sleeve block, and the calibration distance sensor can sense a distance of the sleeve block. When a distance value sensed by the calibration distance sensor and a distance value sensed by the main distance sensor are the same as the driving vibration range value set by the circuit board.

The present invention has the following technical effects and advantages.
1. According to the present invention, with the motor drive range adjusting mechanism, the miniature electric cylinder pushes the connecting block to move to the right, and the connecting block causes the concave block to move to the right; the two connecting shafts respectively drive one ends of the two socket rods to move synchronously to the right, and the other ends of the socket rods drive the pull shaft to move downward and the other pull shaft to move upward; the hinge block drives the socket block to move downward, and the two limit strips can limit and adjust the driving vibration range of the polarization shaft, so that the vibration offset range of the output end of the ultrasonic motor can be accurately adjusted according to actual needs.
2. According to the present invention, with the sealed vibration limit mechanism, the transmission shaft can synchronously drive the polarization shaft to vibrate, the polarization shaft vibrates ultrasonically at a high frequency within the rubber ring, and the rubber ring is in deformation linkage, so that the polarization shaft comes into contact with inner walls of the two limit strips. The outer limit ring is supported by the housing, and the outer limit ring supports the inner limit ring, so that the limit support ring can limit and rotate the outer wall of the polarization shaft, and the polarization shaft can perform ultrasonic vibration within a specified range.
3. According to the present invention, with the sensing calibration mechanism, the support block drives the inclined strip to move downward, the main distance sensor approaches the stationary sleeve block, and the sleeve block and the support block slide downward on the inner limit ring. When the distance value sensed by the calibration distance sensor and the distance value sensed by the main distance sensor are the same as the driving vibration range value set by the circuit board, the polarization shaft can be driven to vibrate within a limited range between the two limit strips.

Due to the interaction of the above functions, the two limit strips can first limit and adjust the driving vibration range of the polarization shaft, then the limit support ring can limit and rotate the outer wall of the polarization shaft, and finally, the distance value sensed by the calibration distance sensor and the distance value sensed by the main distance sensor are the same as the driving vibration range value set by the circuit board. In conclusion, the vibration offset range of the output end of the ultrasonic motor can be accurately adjusted according to actual needs.

### BRIEF DESCRIPTION OF DRAWINGS

FIG. 1 is a schematic diagram of a main view structure of an ultrasonic motor for a dental scaler of the present invention;

FIG. 2 is a schematic diagram of a vertical section structure of an ultrasonic motor for a dental scaler of the present invention;

FIG. 3 is a schematic diagram of a partial cut-off structure at a connection between an outer limit ring and an inner limit ring of the present invention;

FIG. 4 is a schematic diagram of an enlarged structure at A in FIG. 3 of the present invention;

FIG. 5 is a schematic diagram of a partial cut-off structure at a connection between a housing and an ultrasonic generator of the present invention;

FIG. 6 is a schematic diagram of a vertical section structure of an ultrasonic motor for a dental scaler of the present invention;

FIG. 7 is a schematic diagram of an enlarged structure at B in FIG. 6 of the present invention; and

FIG. 8 is a schematic diagram of a partial structure of a sensing calibration mechanism of the present invention.

Reference signs: 1. housing; 2. stator; 3. rotor; 4. transmission shaft; 5. polarization shaft; 6. miniature electric cylinder; 7. connecting block; 8. concave block; 9. connecting shaft; 10. socket rod; 11. pull shaft; 12. hinge block; 13. socket block; 14. limit strip; 15. inner limit ring; 16. guide column; 17. guide frame; 18. rotating ring; 19. eccentric block; 20. ultrasonic generator; 21. rubber ring; 22. outer limit ring; 23. limit support ring; 24. tip; 25. support block; 26. inclined strip; 27. sleeve block; 28. main distance sensor; 29. stationary sleeve block; 30. calibration distance sensor; and 31. circuit board.

### DESCRIPTION OF EMBODIMENTS

The technical solutions in embodiments of the present invention are clearly and completely described below with reference to the accompanying drawings in the embodiments of the present invention. Apparently, the described embodiments are merely some rather than all of the embodiments of the present invention. Based on the embodiments of the present invention, all other embodiments obtained by those of ordinary skill in the art without creative efforts shall fall within the protection scope of the present invention.

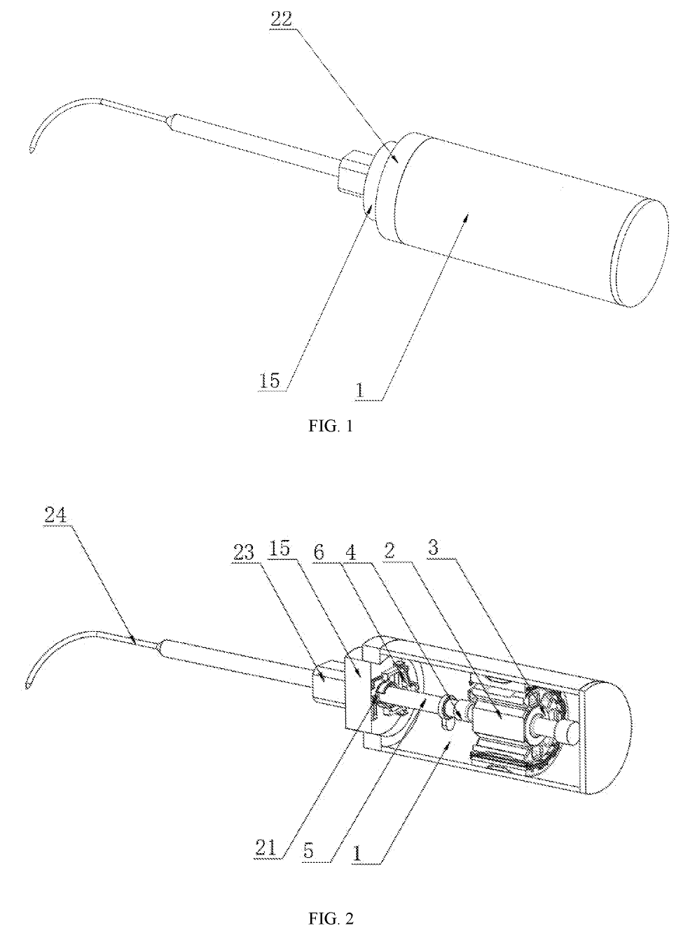

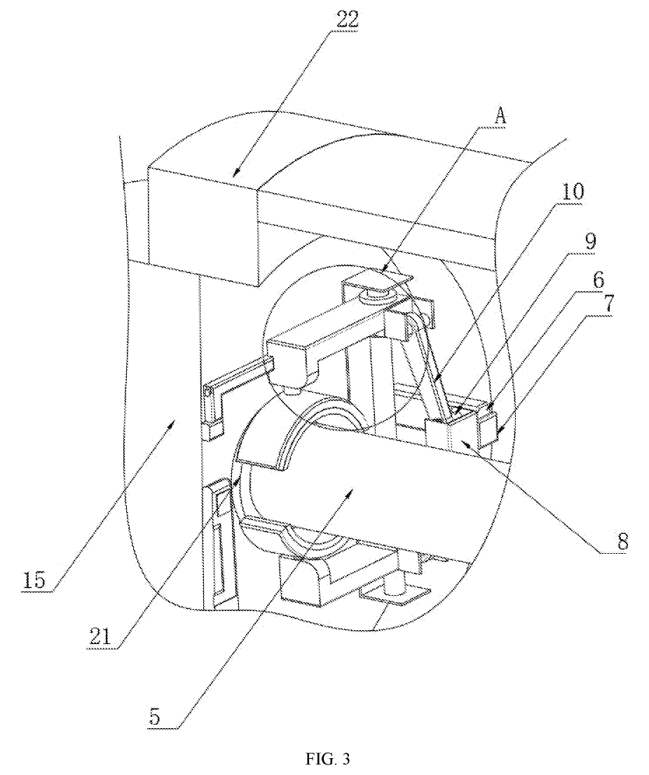

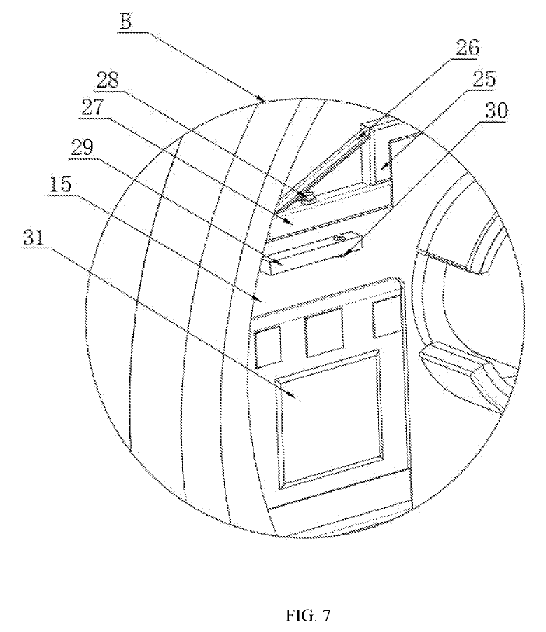

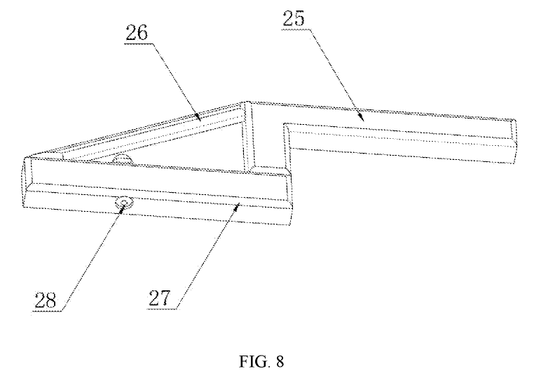

As shown in FIGS. 1 to FIG. 8, an ultrasonic motor for a dental scaler is provided with a motor drive range adjusting mechanism, a sealed vibration limit mechanism, and a sensing calibration mechanism. The mechanisms can be disposed to accurately adjust a vibration offset range of an output end of the ultrasonic motor according to actual needs. Specific structure arrangement of the mechanisms is as follows.

In this technical solution, as shown in FIGS. 1 to FIG. 4, a stator 2 is fixed on an inner wall of a housing 1, a rotor 3 is rotatably connected to an inner wall of the stator 2, and a motor drive range adjusting mechanism is fixedly mounted at one end of the rotor 3; the motor drive range adjusting mechanism includes a transmission shaft 4 fixedly disposed at one end of the rotor 3, and a polarization shaft 5 is fixedly connected to one end of the transmission shaft 4, one side of the polarization shaft 5 is provided with a miniature electric cylinder 6, a connecting block 7 is fixedly connected to an output end of the miniature electric cylinder 6, and a concave block 8 is fixedly connected to one side of the connecting block 7;

two connecting shafts 9 are fixedly connected to an inner wall of the concave block 8, a socket rod 10 is rotatably connected to an outer wall of each of the connecting shafts 9, a pull shaft 11 is rotatably connected at a position that is on an inner wall of the socket rod 10 and that is away from the connecting shaft 9, and a hinge block 12 is fixedly connected to one end of the pull shaft 11; a socket block 13 is fixedly connected to one side of the hinge block 12, a limit strip 14 is fixedly mounted at one end of the socket block 13, and an inner limit ring 15 is fixedly mounted at one end of the miniature electric cylinder 6; an inner wall of the inner limit ring 15 is provided with a sealed vibration limit mechanism; and a sensing calibration mechanism is mounted on one side of the socket block 13.

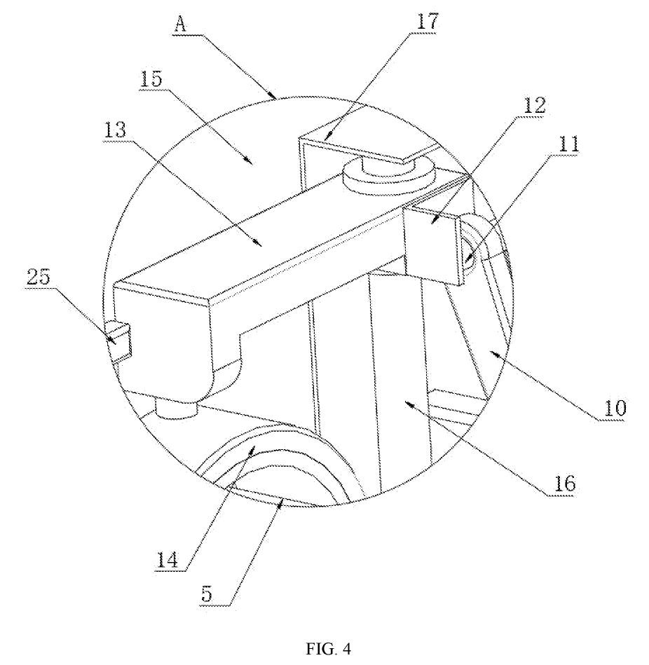

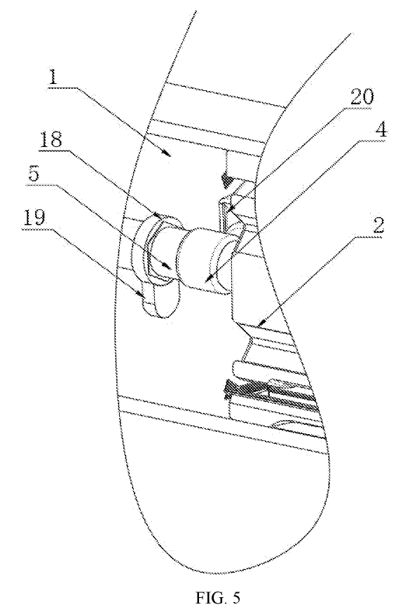

In this technical solution, as shown in FIGS. 4 to FIG. 5, an inner wall of the socket block 13 is provided with a guide column 16, and both the socket blocks 13 are in sliding connection with the guide column 16; and a guide frame 17 is fixedly mounted at the top of the guide column 16, both the socket blocks 13 are in sliding connection with the guide frame 17, and the guide frame 17 is fixedly connected with the inner limit ring 15, so that the socket block 13 slides downward along an outer wall of the guide column 16, and the socket block 13 slides downward along an inner wall of the guide frame 17, thereby achieving guided sliding operation. A rotating ring 18 is fixedly connected at a position that is on an outer wall of the polarization shaft 5 and that is close to the transmission shaft 4; and an eccentric block 19 is fixedly connected at the bottom of an outer wall of the rotating ring 18, so that the polarization shaft 5 drives the rotating ring 18 to rotate, the rotating ring 18 drives the eccentric block 19 to rotate, and the eccentric block 19 can rotate eccentrically to generate an eccentric vibration force.

One side of the transmission shaft 4 is provided with an ultrasonic generator 20, and the ultrasonic generator 20 is fixedly connected with the housing 1, so that the ultrasonic generator 20 can perform ultrasonic-assisted vibration on the transmission shaft 4. In this way, the transmission shaft 4 can synchronously drive the polarization shaft 5 to vibrate to achieve vibration operation of the polarization shaft 5.

In this technical solution, as shown in FIGS. 1 to FIG. 5, the sealed vibration limit mechanism includes a rubber ring 21 fixedly disposed on an inner wall of the inner limit ring 15; the rubber ring 21 is rotatably connected with the polarization shaft 5, an outer limit ring 22 is mounted on an outer wall of the inner limit ring 15, both the housing 1 and the inner limit ring 15 are fixedly connected with the outer limit ring 22, a limit support ring 23 is fixedly connected to one side of the inner limit ring 15, and the polarization shaft 5 is rotatably connected with the limit support ring 23; and a tip 24 is fixedly connected to one end of the polarization shaft 5. The rubber ring 21 has an annular vertical section, and the rubber ring 21 is made of a rubber material.

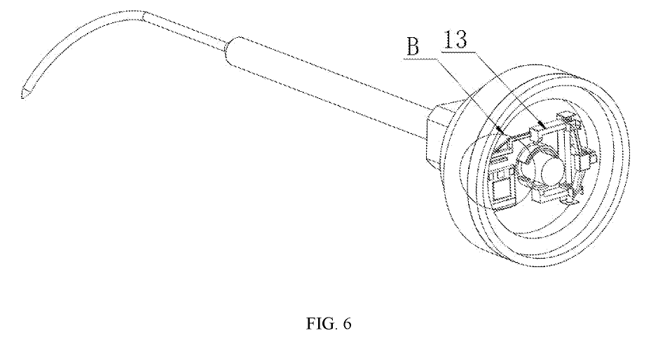

In this technical solution, as shown in FIGS. 6 to FIG. 8, the sensing calibration mechanism includes a support block 25 fixedly disposed on one side of the socket block 13; an inclined strip 26 is fixedly connected to one side of the support block 25, a sleeve block 27 is fixedly mounted at the bottom of the support block 25, a main distance sensor 28 is fixedly connected to an inner wall of the sleeve block 27, a stationary sleeve block 29 is disposed below the sleeve block 27, the stationary sleeve block 29 is fixedly connected with the inner limit ring 15, and both the support block 25 and the sleeve block 27 are in sliding connection with the inner limit ring 15; and a calibration distance sensor 30 is fixedly mounted on an inner wall of the stationary sleeve block 29, and a circuit board 31 fixedly connected with the inner limit ring 15 is disposed below the stationary sleeve block 29. A top surface of the calibration distance sensor 30 is in the same horizontal plane as an upper surface of the stationary sleeve block 29, and a lower surface of the sleeve block 27 is disposed in parallel with the upper surface of the stationary sleeve block 29.

The working principle of the ultrasonic motor for the dental scaler of the present invention is as follows.

Step 1: When the motor is mounted, the housing 1 is mounted in a mounting groove of the dental scaler, and sealing adhesive is injected into edge gaps to implement installation of the housing 1.

Step 2: When a motor drive range is adjusted, a driving vibration range value is set by using the circuit board 31, then the miniature electric cylinder 6 is powered by the circuit board 31, the miniature electric cylinder 6 pushes the connecting block 7 to move to the right, the connecting block 7 causes the concave block 8 to move to the right, the concave block 8 drives the two connecting shafts 9 to move synchronously to the right, the two connecting shafts 9 respectively drive one ends of the two socket rods 10 to move synchronously to the right, and the other ends of the socket rods 10 drive the pull shaft 11 to move downward and the other pull shaft 11 to move upward. The hinge block 12 is driven by the pull shaft 11 to move downward, then the hinge block 12 drives the socket block 13 to move downward, the socket block 13 slides downward along an outer wall of the guide column 16, while the socket block 13 slides downward along an inner wall of the guide frame 17, the socket block 13 causes the limit strip 14 to move downward, the limit strip 14 moves downward, and the other limit strip 14 moves upward. The two limit strips 14 can limit and adjust the driving vibration range of the polarization shaft 5.

Step 3: During sensing calibration, when the socket block 13 moves downward, it drives the support block 25 to move downward, the support block 25 then drives the inclined strip 26 to move downward, the inclined strip 26 causes the sleeve block 27 to move downward, the sleeve block 27 drives the main distance sensor 28 to move downward, the main distance sensor 28 approaches the stationary sleeve block 29, and the stationary sleeve block 29 is supported by the inner limit ring 15. At the same time, the sleeve block 27 and the support block 25 slide downward on the inner limit ring 15. In this way, the main distance sensor 28 can sense a distance of the stationary sleeve block 29, and the calibration distance sensor 30 can sense a distance of the sleeve block 27. When a distance value sensed by the calibration distance sensor 30 and a distance value sensed by the main distance sensor 28 are the same as the driving vibration range value set by the circuit board 31, the miniature electric cylinder 6 is turned off through the circuit board 31, so that the polarization shaft 5 can be driven to vibrate within a limited range between the two limit strips 14.

Step 4: When sealed ultrasonic vibration is limited, the stator 2 is supported by the housing 1, the circuit board 31 activates the stator 2, causing the rotor 3 to rotate, the rotor 3 then drives the transmission shaft 4 to rotate, and the transmission shaft 4 causes the polarization shaft 5 to rotate. At the same time, the polarization shaft 5 drives the rotating ring 18 to rotate, the rotating ring 18 drives the eccentric block 19 to rotate, and the eccentric block 19 rotates eccentrically, so that the polarization shaft 5 vibrates. In addition, the ultrasonic generator 20 can perform ultrasonic-assisted vibration on the transmission shaft 4. In this way, the transmission shaft 4 can synchronously drive the polarization shaft 5 to vibrate, the polarization shaft 5 vibrates ultrasonically at a high frequency within the rubber ring 21, and the rubber ring 21 is in deformation linkage, so that the polarization shaft 5 comes into contact with inner walls of the two limit strips 14. In this way, the polarization shaft 5 implements ultrasonic-driven vibration, and the polarization shaft 5 drives the tip 24 to vibrate. The outer limit ring 22 is supported by the housing 1, and the outer limit ring 22 supports the inner limit ring 15, so that the inner limit ring 15 can limit an outer wall of the rubber ring 21, and the limit support ring 23 can limit and rotate the outer wall of the polarization shaft 5.

Contents not described in detail in the specification belong to the prior art known to those skilled in the art, and model parameters of each electrical appliance are not specifically limited, therefore, a conventional device can be used. Electrical control elements not mentioned in this technical solution are not shown in the figures because they belong to the prior art, and details are not described herein again.

The above descriptions are merely preferred embodiments of the present invention, and are not intended to limit the present invention. Any modification, equivalent replacement, or improvement made within the spirit and principle of the present invention should be included in the protection scope of the present invention.

What is claimed is:

1. An ultrasonic motor for a dental scaler, comprising a housing (1), a stator (2), and a rotor (3), the stator (2) being fixed on an inner wall of the housing (1), and the rotor (3) being rotatably connected to an inner wall of the stator (2), wherein a motor drive range adjusting mechanism is fixedly mounted at one end of the rotor (3);
the motor drive range adjusting mechanism comprises a transmission shaft (4) fixedly disposed at one end of the rotor (3), and a polarization shaft (5) is fixedly connected to one end of the transmission shaft (4), one side of the polarization shaft (5) is provided with a miniature electric cylinder (6), a connecting block (7) is fixedly connected to an output end of the miniature electric cylinder (6), and a concave block (8) is fixedly connected to one side of the connecting block (7);
two connecting shafts (9) are fixedly connected to an inner wall of the concave block (8), a socket rod (10) is rotatably connected to an outer wall of each of the connecting shafts (9), a pull shaft (11) is rotatably connected at a position that is on an inner wall of the socket rod (10) and that is away from the connecting shaft (9), and a hinge block (12) is fixedly connected to one end of the pull shaft (11);
a socket block (13) is fixedly connected to one side of the hinge block (12), a limit strip (14) is fixedly mounted at one end of the socket block (13), and an inner limit ring (15) is fixedly mounted at one end of the miniature electric cylinder (6);
an inner wall of the inner limit ring (15) is provided with a sealed vibration limit mechanism; and
a sensing calibration mechanism is mounted on one side of the socket block (13).

2. The ultrasonic motor for a dental scaler according to claim 1, wherein both the concave block (8) and the hinge block (12) have concave cross sections, and the pull shaft (11) and the connecting shafts (9) have circular vertical sections.

3. The ultrasonic motor for a dental scaler according to claim 1, wherein the limit strip (14) has an arc-shaped vertical section, and inner walls of both the limit strips (14) are smooth surfaces.

4. The ultrasonic motor for a dental scaler according to claim 1, wherein an inner wall of the socket block (13) is provided with a guide column (16), and both the socket blocks (13) are in sliding connection with the guide column (16); and
a guide frame (17) is fixedly mounted at the top of the guide column (16), both the socket blocks (13) are in sliding connection with the guide frame (17), and the guide frame (17) is fixedly connected with the inner limit ring (15).

5. The ultrasonic motor for a dental scaler according to claim 1, wherein a rotating ring (18) is fixedly connected at a position that is on an outer wall of the polarization shaft (5) and that is close to the transmission shaft (4); and
an eccentric block (19) is fixedly connected at the bottom of an outer wall of the rotating ring (18).

6. The ultrasonic motor for a dental scaler according to claim 1, wherein one side of the transmission shaft (4) is provided with an ultrasonic generator (20), and the ultrasonic generator (20) is fixedly connected with the housing (1).

7. The ultrasonic motor for a dental scaler according to claim 1, wherein the sealed vibration limit mechanism comprises a rubber ring (21) fixedly disposed on an inner wall of the inner limit ring (15);
the rubber ring (21) is rotatably connected with the polarization shaft (5), an outer limit ring (22) is mounted on an outer wall of the inner limit ring (15), both the housing (1) and the inner limit ring (15) are fixedly connected with the outer limit ring (22), a limit support ring (23) is fixedly connected to one side of the inner limit ring (15), and the polarization shaft (5) is rotatably connected with the limit support ring (23); and
a tip (24) is fixedly connected to one end of the polarization shaft (5).

8. The ultrasonic motor for a dental scaler according to claim 7, wherein the rubber ring (21) has an annular vertical section, and the rubber ring (21) is made of a rubber material.

9. The ultrasonic motor for a dental scaler according to claim 1, wherein the sensing calibration mechanism comprises a support block (25) fixedly disposed on one side of the socket block (13);
an inclined strip (26) is fixedly connected to one side of the support block (25), a sleeve block (27) is fixedly mounted at the bottom of the support block (25), a main distance sensor (28) is fixedly connected to an inner wall of the sleeve block (27), a stationary sleeve block (29) is disposed below the sleeve block (27), the stationary sleeve block (29) is fixedly connected with the inner limit ring (15), and both the support block (25) and the sleeve block (27) are in sliding connection with the inner limit ring (15); and
a calibration distance sensor (30) is fixedly mounted on an inner wall of the stationary sleeve block (29), and a circuit board (31) fixedly connected with the inner limit ring (15) is disposed below the stationary sleeve block (29).

10. The ultrasonic motor for a dental scaler according to claim 9, wherein a top surface of the calibration distance sensor (30) is in the same horizontal plane as an upper surface of the stationary sleeve block (29), and a lower surface of the sleeve block (27) is disposed in parallel with the upper surface of the stationary sleeve block (29).
